(19) United States
(12) Patent Application Publication
(10) Pub. No.: US 2015/0081574 A1
(43) Pub. Date: Mar. 19, 2015

(54) SYSTEM AND METHOD TO GATHER, CORRELATE, ANALYZE, AND REPORT INFORMATION

(71) Applicants: Nicholas Jonathan Selby, Tarrant, TX (US); David Henderson, Tarrant, TX (US)

(72) Inventors: Nicholas Jonathan Selby, Tarrant, TX (US); David Henderson, Tarrant, TX (US)

(73) Assignee: STREETCRED SOFTWARE, INC., Arlington, TX (US)

(21) Appl. No.: 14/462,399

(22) Filed: Aug. 18, 2014

Related U.S. Application Data
(60) Provisional application No. 61/866,877, filed on Aug. 16, 2013.

(51) Int. Cl. G06Q 50/26; G06F 17/30; H04L 29/08; G06F 3/0481

(52) U.S. Cl. CPC G06Q 50/26; G06F 3/0481; G06F 17/30943; H04L 67/1097
USPC 705/311

(57) ABSTRACT

A system and method to gather, correlate, analyze, and report information to provide a user with an ability to more efficiently and safely track and arrest fugitives for whom arrest warrants have been issued and collect moneys owed by fugitives, and provide warrant management and a fugitive-tracking lifecycle.

### CROSS-REFERENCE TO RELATED APPLICATION

This Patent Application claims priority to U.S. Provisional Patent Application Ser. No. 61/866,877 titled System and Method to Gather, Correlate, Analyze, and Report Information, and filed Aug. 16, 2013, the entire contents of which are herein incorporated by reference in its entirety.

### BACKGROUND

1. Field

The present inventive concept pertains to a system and method to gather, correlate, analyze, and report information to provide a user with an ability to more efficiently and safely track and arrest fugitives for whom arrest warrants have been issued and collect moneys owed by fugitives, and provide warrant management and a fugitive-tracking lifecycle.

2. Discussion of Related Art

Law enforcement agencies and court systems are currently faced with problematic arrest-warrant backlogs for individuals wanted for violations of the law ranging from less-serious offenses, e.g., public intoxication and traffic offenses, to more-serious offenses, e.g., manslaughter and burglary. These backlogs cost municipalities millions in revenues and maintenance fees each year. Additionally, fines and fees associated with these warrants represent delayed and sometimes missed opportunities to generate revenue for the municipalities and state government.

Traditional methods utilized by U.S. marshals or “warrant officers” who seek to arrest persons being sought by police who have an arrest warrant, i.e., “fugitives,” are tedious and inefficient to use, and often prove to provide inaccurate information for locating and apprehending such fugitives. For example, basic research, route management of a user, and inefficiencies incurred from lugging of boxes of paper records, results in a very slow process. Further, such traditional methods require courts to print a copy of a warrant for service, which is then passed along to one or more warrant officers. In this scenario, the warrant officer typically obtains copies of the warrant, which typically includes a first copy of the warrant for the fugitive's home address and a second copy of the warrant for the fugitive's work address, and then places the copies in a box containing other warrants associated with a same zip code as the fugitive's home address, and one copy in a box containing many other warrants in the same zip code as the fugitive's work address. Thereafter, the officer researches the fugitive's home utilizing a service such as a county appraisal district website or a private, per-fee data service, e.g., the system made available under the trademark LEXISNEXIS®. The officer then obtains a photograph of the fugitive from a driver's license bureau and prints a copy for the home and work files. The officer may conduct other associates research in preparation of physically locating the fugitive in the field. Using such a traditional method, an experienced and competent warrant officer may typically successfully locate approximately five fugitives per eight-hour day while working in the field. Due to the aforementioned shortcomings of traditional methods, warrant officers are required to spend many days not working in the field, but instead conducting the aforementioned research.

A smaller city may have thousands or even tens of thousands of outstanding warrants to be cleared while larger cities may have hundreds of thousands or even millions of outstanding warrants to be cleared. In some agencies, a court will place warrant information into spreadsheets, which are then digitally sorted by zip code and prioritized by an amount owed to the court by the fugitive. Using the amount owed metric is a terrible method of prioritizing warrants because such may be inversely related to the likelihood of locating a fugitive for at least the reason that a fugitive who owes more money will likely take more steps to hide from warrant officers and the police.

The databases in which warrants are stored are typically aged and non-relational, and often utilize obscure mainframe computer systems that are incapable of being easily searched, audited, or providing sufficient capabilities to analyze their contents. Even more modern systems, e.g., a system made available under the trademark INCODE® by Tyler Technologies, are merely conversions from mainframe programs and non-relational databases. While such modern systems may function under common operating systems, e.g., a system made available under the trademark WINDOWS®, or using cloud services, their data structures are very similar to and in some cases indistinguishable from non-relational flat file mainframe-type databases. Thus, these modern systems provide users with no method to conduct any meaningful relational and comparative analysis.

Accordingly, there is a need for a system and method operable to communicate with and obtain data from existing systems and convert the data obtained to a useful format that is normalized. There is also a need for a system and method operable to aggregate contextual information obtained from a variety of different sources, e.g., public databases, law enforcement databases, and open-source databases. There is also a need for a system and method operable to analyze information contained in warrants, predict warrants most likely to be successfully served, and prioritize or rank warrants in an order to allow officers to search for and ultimately catch fugitives.

### SUMMARY

The present inventive concept described herein remedies the aforementioned problems by providing a unique system and method to gather, correlate, analyze, and report information to provide a user with an ability to more efficiently and safely track and arrest fugitives for whom arrest warrants have been issued and collect moneys owed by fugitives, and provide warrant management and a fugitive-tracking lifecycle. For purposes herein, a fugitive tracking lifecycle is a process of eliminating from consideration fugitives who do not qualify for tracking based on one or more factors. For example, the present inventive concept is operable to consider one or more factors based on data, e.g., warrant information, too unreliable to effectively locate a fugitive and/or clear a warrant based on an analysis of the type of crime and the relative “value” to the jurisdiction of capture and clearance. As an example, it is always worth going to great lengths to capture a fugitive associated with a serious crime, e.g., murder, even when his license has been expired for years and no public or police records indicating his whereabouts can be located for an extended amount of time, e.g., five or more years. On the other hand, it is almost never worth seeking a fugitive associated with a less serious crime, e.g., a traffic violation, under the same circumstances.

The system of the present inventive concept is configured to monitor and track all warrant officers that access and view the data available via the system and associated with each of the fugitives, to enable collaboration between warrant officers, police managers, and/or external entities, e.g., collection agencies or private investigators, to record notes and/or communication between law enforcement and/or other parties that is associated with each of the fugitives, periodically seek new data associated with each of the fugitives from a wide variety of public and private databases and other sources, to manage and store data associated with each of the fugitives.

The system of the present inventive concept generally includes a memory operable to store data, a scoring server operable to prioritize and rank data in a list, a configuration server operable to be configured by a user of the system, and a server operable to provide an access portal to the user to the system, e.g., access via a computer of the user connected to the Internet, each in wired and/or wireless communication with each other.

It is an object of the present inventive concept to provide a system and method that provides a user, e.g., an agency administrator, a city manager, and/or a city councilmember, with data associated with one or more warrant officers and/or one or more fugitives that is processed via a processor and presented via display of the system in a manner to enable the user to evaluate performance and/or likelihood of success of each of the warrant officers.

It is an object of the present inventive concept to provide a system and method operable to manage a route of a user, e.g., to propose one or more routes between the user and one or more fugitives that is based on data associated with the user and one or more fugitives. The route(s) may be proposed to the user via a display of the system. The display may simultaneously provide location information for a plurality of fugitives and associated routes between the plurality of fugitives and the user and may include geospatial orientation data via a processor associated with the display. For example, the system of the present inventive concept is operable to base a proposed route on data that may indicate that a standard route, e.g., a route with a straightest distance or a quickest route from a present location of the user to a desired location, may not be ideal if the system identifies one or more of (i) a presence of other fugitives within a predetermined geographic proximity to the present location and/or desired location, (ii) a presence of others associated with a fugitive within a predetermined geographic proximity to the present location and/or desired location, and (iii) other points of interest within a predetermined geographic proximity to the present location and/or desired location. In such a scenario, the system is configured to (i) alert the user to the logic, e.g, via the display, and (ii) provide a route in view of the logic. In this manner, the user is able to travel to the desired location while possibly coming into contact with other fugitives, others associated with the fugitive, and/or other points of interest.

It is an object of the present inventive concept to provide a system and method with intelligent, learning capabilities that provides a user with predictive intelligence to optimize information and data resources, which taken as a whole and processed by the system, and predict which fugitives are most likely to be located. The system of the present inventive concept utilizes and processes various factors, e.g., one hundred factors, to yield a result that can be easily understood by the user. Such factors may include age, violation information, warrant information, type of vehicle and house owned or leased by the fugitive, information related to one or more neighborhoods associated with the house owned or leased by the fugitive.

It is an object of the present inventive concept to provide a system and method configured to produce a score, e.g., between one and one hundred, to provide an indicator related to confidence or likelihood the information is accurate, e.g., information related to a possible location of a fugitive and/or likelihood that a fugitive is able to pay a fines and/or fee associated with a violation and/or a warrant.

It is an object of the present inventive concept to provide a system and method that allows a user, e.g., a warrant officer, to prioritize their workflow and target fugitives sought.

It is an object of the present inventive concept to provide a system and method having a scoring engine, a scoring server, a configuration server and a customer premises equipment server, which provides bridging and/or translation software and/or hardware, to combine data and yield a result of the combination. By translating obscure and non-user-friendly data formats and importing them into open standards and data protocols, e.g., structured query language, the present inventive concept is operable to compare, correlate, and analyze information, e.g., correlate information contained in warrants about fugitives with information contained in law enforcement records management systems, state and county records databases, e.g., listings of gang members, sex offenders, parolees, probationers, and/or subjects of orders of protection, databases of automatic license plate readers, field intelligence reports, arrest reports, intelligence reports, and/or raw intelligence, motor vehicle information, dispatch records, and/or other records including court records and/or judgments.

It is an object of the present inventive concept to provide a system and method configured to aggregate and combine data from public databases, open-source databases, proprietary databases, and commercial databases to provide users with highly accurate and useful predictive intelligence capabilities, e.g., inform a user of a predicted intent and/or location of a fugitive, and/or their ability to pay any outstanding fines and fees.

It is an object of the present inventive concept to provide a system and method configured to provide an analysis that identifies a plurality of clusters of fugitives in one or more common geographic areas, e.g., common places of employment or common neighborhoods, to facilitate coordination of location and capture efforts by a user.

It is an object of the present inventive concept to provide a system and method configured to provide accounting and tracking facilities to courts, allowing them to track status or progress in arresting and fugitives as well as historical comparisons and predictions regarding future captures based on current performance of one or more warrant officers.

It is an object of the present inventive concept to provide a system and method configured to provide an accurate accounting of warrant-officer time account and report performance metrics for a warrant officer, e.g., success at serving warrants. In this manner, the information can be used to compare various warrant officers.

It is an object of the present inventive concept to provide a system and method configured to provide an automated method of extracting warrant information from court software and supporting contextually relevant information from other systems, e.g., system containing one or more photographs of the fugitive, graphics, and/or contact information, and automatically generating postcards to be sent by the agency, e.g., via the US Postal service or private courier, to fugitives at their address of record informing them of charges and outstanding warrants and offering contact information and an Internet website and telephonic contact information to allow the fugitive to surrender.

It is an object of the present inventive concept to provide a system and method configured to provide an automated method of extracting warrant information from court software and automatically generating telephone initiated from the agency telephone number to fugitives at their telephone contact of record informing them of charges and outstanding warrants and offering an interactive voice menu to allow the fugitive to surrender or immediately pay fines and fees to clear the warrants during the same telephone call through a credit card processing facility provided by the present inventive concept in association with one or more banks and/or credit card processing accounts.

It is an object of the present inventive concept to provide a system and method configured to provide a ranking of likelihood information about a location of a violation as well as listed and entered addresses of one or more fugitives.

It is an object of the present inventive concept to provide a system and method configured to use predictive analysis techniques to achieve a more efficient hit rate, which may lead users to one or more actual addresses frequented by the one or more fugitives and/or one or more phone numbers used by the one or more fugitives while disqualifying bad, false, or outdated information. For example, this may be achieved via gathering and then by comparing addresses and/or telephone numbers from a range of sources including, but not limited to, LE, public, open records, arrest reports, statements by witnesses, neighbors, friends, associates, family members, other officers and acquaintances, normalizing and correlating these against criteria including but not limited to date, further information, e.g, a disconnect notice, and comparing these data, information and analyses to one another and then to observations made by officers as to the veracity of the data or information provided.

It is an object of the present inventive concept to provide a system and method made available via a secure, encrypted connection to any user, e.g., officers, court clerks, and analysts, at no charge to an agency associated with the user.

It is an object of the present inventive concept to provide a system and method configured to provide users to a secure collaboration environment containing information organized based on one or more fugitives, providing reminders (e.g, of dates, times and places during or in which a fugitive may be located, e.g., a mother mentions that her fugitive son is away for the weekend but will be back on Monday, the system of the present inventive concept is operable to automatically generate and/or send an email, and/or text SMS message to an officer informing or reminding him that the fugitive will return on that date and time), messaging (e.g., in addition to the aforementioned, a concept called “automated deconfliction” in which the system of the present inventive concept is operable to detect when one officer views or interacts with a fugitive whose file has been viewed or interacted with by another officer, the system of the present inventive concept is operable to automatically generate a message to both officers, informing each of the other's involvement, thereby ensuring that any changes/additions/amendments/notes/reminders set or left by one regarding that fugitive is communicated automatically with the other. Another name for this feature is the “Starsky & Hutch Avoidance Feature”, because it avoids the situation often seen on cop shows in which one group of cops raids an establishment being surveilled by another group of cops and they all start yelling at one another before ultimately working together and getting into a car chase and then getting celebratorily drunk, an ability to annotate and update key aspects of information related to one or more fugitives, e.g., information the user knows to be accurate, and/or share information with other users.

It is an object of the present inventive concept to provide a system and method configured to provide users with detailed statistics regarding performance of warrant officers including, but not limited to, successful contacts made with one or more fugitives as well as accuracy of information input by warrant officers, e.g., addresses phone numbers, inability to produce any information or unknown, and the like. In this manner, the present inventive concept is configured to furnish a detailed report to allow a user to compare performance of various warrant officers in serving warrants by outcome, e.g., paid, payment plan, sat-out in jail, and/or community service.

It is an object of the present inventive concept to provide a system and method configured to provide users, e.g., agency and court supervisors and administrators, with detailed statistics regarding, for example, total number of citations of one or more fugitives, warrants grouped based on one or more fugitives, any warrant officers associated with one or more fugitives, category (e.g., misdemeanor, felony, etc. or misdemeanor traffic, misdemeanor assault, felony non-violent, felony violent, etc.), violation of one or more fugitives, violation location of one or more fugitives, home and/or word address, e.g., zip codes, of one or more fugitives, and/or race of one or more fugitives. This information may be further classified and/or compared based on a timeframe selected by the user, e.g., yearly, quarterly, monthly, weekly, and daily.

It is an object of the present inventive concept to provide a system and method configured to provide a total number of open warrants, cleared warrants by dollar value, i.e., details with the fugitive paid a fine in full or entered into a payment plan, race of the fugitive, and/or gender of the fugitive.

It is an object of the present inventive concept to provide a system and method configured to provide an analysis of citations issued, e.g., on a daily basis, with projections based on historical per warrant officer averages for both paid, warrant, and cleared status. It is foreseen that the report furnished by the present inventive concept may be required by administration at an agency on a periodic basis in a user-configurable format provided by the present inventive concept.

It is an object of the present inventive concept to provide a system and method configured to provide role-based console providing automatic views onto role-appropriate settings. For example, this provides a user in the role of “officer” a view which does not provide Insight into the statistics of other officers or views of gang members, while a user in the role of “marshal” might see gang members and the statistics of all officers and a user in the role of “supervisor” might see all users on the system plus their statistics plus all categories of fugitives, parolees, probationers, sex offenders, gang members and the attempts by “officer” or “marshal” users to mark a given fugitive, for example, as “violent” or as a member of a gang, etc.,

It is an object of the present inventive concept to provide a system and method configured to create, based on information contained in records derived from various sources, e.g., court, warrant officer, clerk and analyst, a geospatial visualization of the fugitive's home and work addresses and display the report to a user.

It is an object of the present inventive concept to provide a system and method configured to query and aggregate fugitive-specific data from heterogeneous sources of law enforcement technology from multiple vendors.

It is an object of the present inventive concept to provide a system and method configured to import, from court records management systems from multiple vendors, citation, warrant and fugitive status, notes, data. It is an object of the present inventive concept to provide a system and method configured to import, proactively and on a fugitive-specific basis, from police agency records management systems from multiple vendors, officer safety and warning and other contextually appropriate data to promote officer safety. It is an object of the present inventive concept to provide a system and method configured to import, proactively and on a fugitive-specific basis, from jail records management systems from multiple vendors, photographs, safety and warning and other contextually appropriate data to promote officer safety. It is an object of the present inventive concept to provide a system and method configured to import sex-offender, parolee and probationer data. It is an object of the present inventive concept to provide a system and method configured to import automatic license plate reader information and parse such for fugitive-specific information, maintain a geo-coded database of multiple-vendor automatic license plate reader information, and provide matching of fugitives. It is an object of the present inventive concept to provide a system and method configured to import city records on time fugitive-specific name and address information. It is an object of the present inventive concept to provide a system and method configured to automatically export and insert fugitive specific information into regional or state warrant databases where available and/or provide a multi-jurisdictional warrant database.

It is an object of the present inventive concept to provide a system and method configured to query, proactively and in real time, fugitive-specific data from various databases including, but not limited to the Texas law enforcement telecommunications system, the Texas crime information center, the national crime information center, and/or the like, to obtain information related to one or more fugitives, associated addresses, associated vehicles, and officer safety information. It is an object of the present inventive concept to provide a system and method configured to display such information to users, e.g., officers and warrant analysts.

It is an object of the present inventive concept to provide a system and method configured to query external repositories of information, e.g., public records, private and commercial records, and proprietary information, on a fugitive-specific, address-specific, and/or vehicle-specific basis, to compile a substantial information background on fugitives, fugitive vehicles, and fugitive addresses.

It is an object of the present inventive concept to provide a system and method configured to operate on existing or free technology, e.g., an existing web browser. It is an object of the present inventive concept to provide a system and method configured to ensure all information which leaves any one of the aforementioned servers of the present inventive concept is encrypted. It is an object of the present inventive concept to provide a system and method configured to provide a facility available to an agency operable to produce, at the agency's discretion and at agency's expense of printing and mailing, postcards automatically generated by the present inventive concept, which are pre-addressed and pre-filled that inform the fugitive of any warrants, fines, and/or fees owed by the fugitive. It is an object of the present inventive concept to provide a system and method configured to provide an internet and/or pay-by-phone option in English and Spanish. In such a scenario, credit card convenience fees may apply as allowed by law.

It is an object of the present inventive concept to provide a system and method configured to provide a facility available to an agency operable, at the agency's discretion and at agency's expense of telephone service and connection fees, to automatically call each fugitive or person associated with the fugitive and play a recorded or voice-synthesized phone message to a person who answers the phone. The phone number may be derived by the present inventive concept from official court records, e.g., a phone number furnished by the fugitive. The message may inform the person who answers the phone, e.g., the fugitive, of any warrants, fines, and/or fees owed and provide an internet or pay-by-phone option in English and Spanish and provide an official receipt number trackable by court staff or police officers. In such a scenario, credit card convenience fees may apply as allowed by law.

It is an object of the present inventive concept to provide a system and method configured to provide a facility made available to the agency, at no cost to the agency, for officers and court personnel, a system configured to accept plea and/or payments from a fugitive, e.g., using a debit or credit card in person, via Internet, and/or via phone, and provide an official receipt. In such a scenario, credit card convenience fees may apply as allowed by law.

It is foreseen that any fees charged in association with use of the present inventive concept may be passed through to a specific party, e.g., a vendor of the present inventive concept. Such fees may relate to one or more software processes the warrants predictively scores and presents the information by making it available in the application and/or the application is reachable in the agency by navigating on the agency LAN to the IP or internal network URL address of the application and being able, from the standpoint of application availability, to log in and view the warrants. Such fees may relate to any arrest or surrender by the fugitive. Such fees may relate to a fugitive paying a warrants or entering into a payment plan to pay a warrant even if a total fine of the warrant is reduced by a magistrate due to financial hardship.

It is foreseen that no fees may be charged if the fugitive is arrested or surrenders and is unable to pay, or “sits out” the sentence for the warrant in jail, the fugitive is arrested or surrenders and is indigent and pays by performing non-cash service to the community, the fugitive dies, and/or the fugitive's warrants are cleared by a magistrate or judge for time served” in association with any other charge.

The aforementioned may be achieved in an aspect of the present inventive concept by providing a system configured to analyze information and produce a report for tracking one or more targets. The system may include a data warehouse, a configuration server in communication with the data warehouse, a scoring server in communication with the data warehouse and configuration server, and/or a user terminal in communication with the data warehouse, configuration server, and scoring server. The data warehouse may be configured to receive and process information related to the one or more targets. The information may be received from one or more sources. The configuration server may be configured to provide synchronization of system resources. For example, the configuration server may be programmed regularly and on a periodicity that varies from module to module. This is sometimes affected by changes to the configuration server being entered and marked as ready to upload, an encrypted connection being made between the configuration server and the system server, new code downloaded from the configuration to the system and the system installs and applies the changes, restarts if necessary, self-tests and sends confirmation of successful or failed installation back to the configuration server.

The aforementioned may be achieved in another aspect of the present inventive concept by providing a computerized method to process a plurality of warrants each associated with a fugitive. The method may include the steps of (i) obtaining, via a computer system, data associated with the fugitives from at least one unsecure database, (ii) obtaining, via the computer system, data associated with the fugitives from at least one secure database, (iii) processing, via a processor of the computer system, (a) the data associated with the fugitives from at least one unsecure database, and (b) the data associated with the fugitives from at least one secure database to yield a listing of the plurality of warrants, and (iv) displaying the listing of the plurality of warrants to a user via a display of the computer system according to at least one of a plurality of orders.

The listing of the plurality of warrants displayed to the user may be prioritized based on one or more of (i) a likelihood of locating and serving each of the fugitives, (ii) a crime associated with each of the fugitives, (iii) a proximity of the user to each of the fugitives, (iv) a time period elapsed from issuance of each of the warrants, (v) an amount owed by each of the fugitives, and/or (vi) a likelihood each of the fugitives can pay an amount associated with a respective one of the fugitives. The amount may be at least one of (i) a fine due to a government by the respective one of the fugitives, (ii) a fee due to the user by the respective one of the fugitives, and/or (iii) a fee due to another party by the respective one of the fugitives. The at least one unsecure database may be a publically-accessible database containing public information. The at least one secure database may be an encrypted database containing private information that is only accessible by law-enforcement personnel.

The aforementioned may be achieved in another aspect of the present inventive concept by providing a communication system with comparative analysis to identify a route to a fugitive based on data associated with a warrant for the fugitive. The system may include at least one of (i) a database server operable to retrieve data associated with the fugitive, (ii) a memory operable to store data associated with the fugitive, (iii) a user-access server operable to allow a user to access the system, and (iv) a configuration server operable to allow the user to configure the system. The database server, the memory, the user-access server, and the configuration server may be associated with an administrative computer system. The system may further include a user computer operable to allow the user to access the system. The user computer may be linked to an agency database.

The aforementioned may be achieved in another aspect of the present inventive concept by providing a method to provide targeting information related to one or more fugitives or targets. The method may include the steps of collecting data about the one or more targets from one or more databases, processing the collected data from the one or more databases, analyzing the collected data received from the one or more databases, producing a report based on the collected data to identify one or more characteristics related to the one or more targets, and/or setting a prioritization score based on a reliability assessment of the one or more characteristics.

The one or more targets may be one or more fugitives, each of the fugitives associated with a warrant issued by a court. The one or more fugitives may be a person for whom a civil complaint or a criminal complaint has been filed or is pending or is governed by a civil or criminal complaint or warrant. The one or more fugitives may have an outstanding warrant. The one or more fugitives may be wanted for questioning in connection with one or more crimes for which a penalty includes a fine or a fee due. Each of the one or more crimes includes a misdemeanor. The one or more fugitives may include a truant.

Each database may include an organizationally specific data collection. Each organizationally specific data collection may include at least one of a database, data store, set of documents, data, information, photographs, arrest record, record of complaint, record of call for service from or related to the one or more fugitives or a person associated with the one or more fugitives by relationship or criminal act or criminal history with the one or more fugitives, official warning, field intelligence report, citation or summons or written warning, officer note, officer comment, dispatch records, computer-aided dispatch file, computerized criminal history, and driver's license database. The method may further include the step of obtaining additional data. The method may further include the step updating the prioritization score based on additional data.

Additional aspects, advantages, and utilities of the present inventive concept will be set forth in part in the description which follows and, in part, will be obvious from the description, or may be learned by practice of the present inventive concept.

The foregoing is intended to be illustrative and is not meant in a limiting sense. Many features and subcombinations of the present inventive concept may be made and will be readily evident upon a study of the following specification and accompanying drawings comprising a part thereof. These features and subcombinations may be employed without reference to other features and subcombinations.

### BRIEF DESCRIPTION OF THE DRAWINGS

The present inventive concept is described in detail below with reference to the attached drawing figures, wherein:

FIG. 1 is a diagram illustrating various components and communication paths between the various components of the present inventive concept; and

FIG. 2 is a diagram illustrating communication paths between various components of the present inventive concept.

The drawing figures do not limit the present inventive concept to the specific examples disclosed and described herein. The drawings are not necessarily to scale, emphasis instead being placed upon clearly illustrating the principles of the present inventive concept.

### DETAILED DESCRIPTION

The following detailed description references the accompanying drawings that illustrate various embodiments of the present inventive concept. The illustrations and description are intended to describe aspects and embodiments of the present inventive concept in sufficient detail to enable those skilled in the art to practice the present inventive concept. Other components can be utilized and changes can be made without departing from the scope of the present inventive concept. The following detailed description is, therefore, not to be taken in a limiting sense. The scope of the present inventive concept is defined only by the appended claims, along with the full scope of equivalents to which such claims are entitled.

### I. TERMINOLOGY

In the following detailed description, terminology is used to describe features of the present inventive concept. For example, references to terms “one embodiment,” “an embodiment,” or “embodiments” mean that the feature or features being referred to are included in at least one aspect of the present disclosure. Separate references to terms “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, process, step, action, or the like described in one embodiment may also be included in other embodiments, but is not necessarily included. Thus, the present inventive concept may include a variety of combinations and/or integrations of the embodiments described herein. Additionally, all aspects of the present disclosure as described herein are not essential for its practice.

Further, in certain situations, the term “logic” refers to hardware, firmware, software, and/or a combination thereof that is configured to perform one or more functions including, but not limited to, those functions of the present inventive concept specifically described herein or are readily apparent to those skilled in the art in view of the description. Such logic may include circuitry having data processing and/or storage functionality. Examples of such circuitry may include, but are not limited to, a microprocessor, one or more processors, e.g., processor cores, a programmable gate array, a microcontroller, an application specific integrated circuit, a wireless receiver, transmitter and/or transceiver circuitry, semiconductor memory, or combinatorial logic.

Logic may be in the form of one or more software modules, such as executable code in the form of an executable application, an application programming interface (API), a subroutine, a function, a procedure, an applet, a servlet, a routine, source code, object code, a shared library/dynamic load library, or one or more instructions. These software modules may be stored in any type of a suitable non-transitory storage medium, or transitory storage medium, e.g., electrical, optical, acoustical or other form of propagated signals such as carrier waves, infrared signals, or digital signals. Examples of non-transitory storage medium may include, but are not limited or restricted to a programmable circuit; a semiconductor memory; non-persistent storage such as volatile memory (e.g., any type of random access memory “RAM”); persistent storage such as non-volatile memory (e.g., read-only memory “ROM”, power-backed RAM, flash memory, phase-change memory, etc.), a solid-state drive, hard disk drive, an optical disc drive, or a portable memory device. As firmware, the executable code is stored in persistent storage.

The term “computerized” generally represents that any corresponding operations are conducted by hardware in combination with software and/or firmware.

The term “computer” generally refers to an apparatus capable of executing at least a portion of code to at least partially perform a computerized process, and having one or more hardware modules, such as a smart phone, tablet computer, desktop computer or other machine.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As the present inventive concept is susceptible to embodiments of many different forms, it is intended that the present disclosure be considered as an example of the principles of the present inventive concept and not intended to limit the present inventive concept to the specific embodiments shown and described.

### II. GENERAL ARCHITECTURE

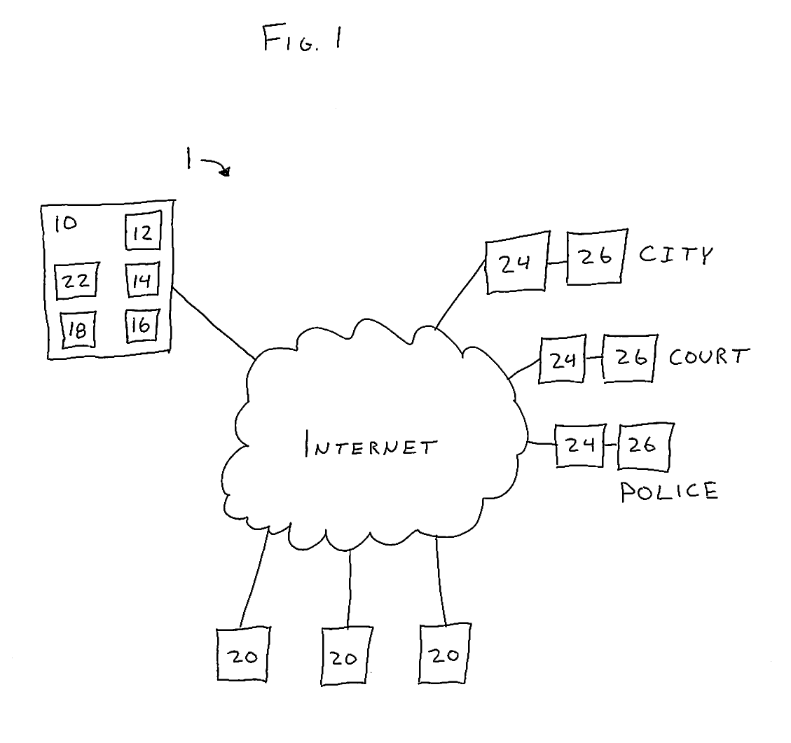

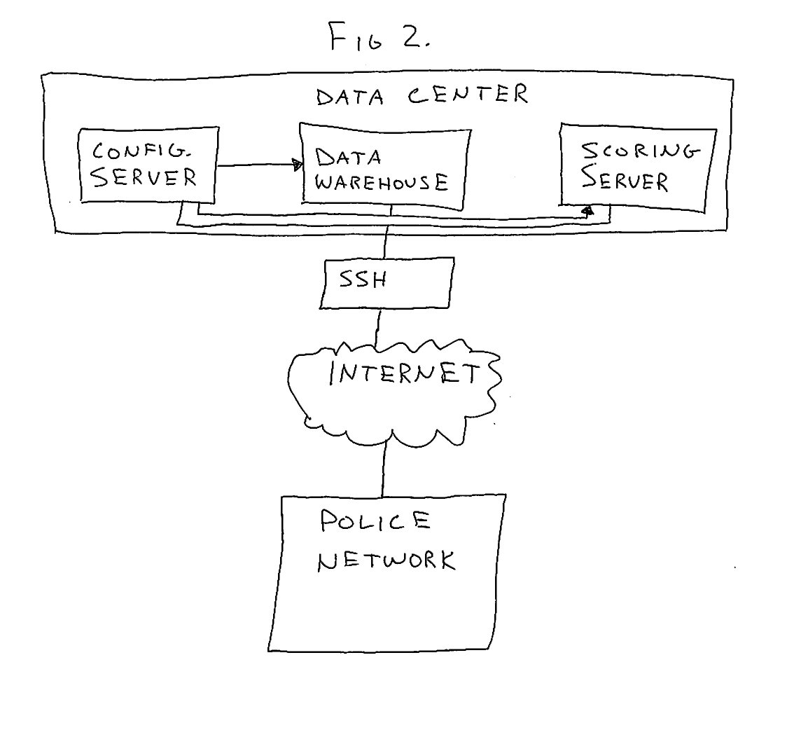

Turning to FIGS. 1 and 2, the present inventive concept generally provides a system 1 having a plurality of components with logic that are connected together wirelessly and/or via a wired connection. The plurality of components include an administrative computer system 10 in communication with a data warehouse or memory 12 operable to store data, a scoring server 14 operable to prioritize and rank the data in a list, a configuration server 16 operable to be configured by one or more users of the system 1, a user-access server 18 operable to provide a plurality of access portals to one or more users of the system 1, e.g., via a plurality of user computers 20 connected to the system 1 via the Internet, and a database server 22 configured to communicate with a plurality of agency computers 24 via the Internet. Using the plurality of components, the system 1 is operable to gather, correlate, and/or analyze information associated with a fugitive and provide the user, e.g., a warrant officer or other personnel associated with fugitive management, locating, and apprehension, with an ability to efficiently and safely track and arrest a fugitive for whom an arrest warrant has been issued, collect money owed by the fugitive, manage warrants, and provide a statistical feedback regarding fugitives, warrants, and users associated with fugitives and warrants.

Each of the database computers 24 is connected to a secure database 26 associated with a database, e.g., a database associated with an agency such as but not limited to a police department computer system with criminal and vehicle data associated with one or more fugitives, a court records system with criminal data associated with one or more fugitives, a government records system with property data associated with one or more fugitives. Each of the database computers 24 are configured to obtain any and all data associated with one or more fugitives from one or more of the systems associated therewith and communicate such to the administrative computer system 10 for further processing by the administrative computer system 10. It is foreseen that such data may be imported from a collection of data residing on an FTP server, which is collected by the administrative computer system 10 via one of the database computers 24. The database computers 24 and/or systems associated therewith may be periodically polled via the administrative computer system 10 to check for updates to the data. The polling period may be set by the user using the configuration server 16. It is also foreseen that a communication link may be established by each of the agency computers 24 to one or more of the systems using a published application programming interface (API). Of course, similar methods of providing connectivity between component and/or systems may be used by the system 1 of present inventive concept without deviating from the scope of the present inventive concept.

The database server 22 is configured to facilitate communication between each of the database computers 24 and the administrative computer system 10 for transmitting and/or receiving data, e.g., warrant and/or fugitive information. Upon receipt of such data, the data is normalized or reformatted to a predetermined format, e.g., per the configuration server 16, classified into one or more individual records for each of the fugitives associated with the data and then ranked in an order based on a predetermined priority setting, e.g., via the scoring server 14. Metadata is then created based on the ranked data to describe such and stored in the memory 12 in a relational manner for retrieval, e.g., by one or more of the user computers 20.

The database server 22 is configured to correct and/or update data contained in the memory 12 using any and all data retrieved from other databases, e.g., data from one or more of the agency computers 24 or any other information depository. As previously discussed, any new data received by the database server 22 is further processed by the administrative computer system 10, i.e., normalized, ranked, associated with metatags, and stored via one or more of the components of the system 10. Communication links may be made via API. It is foreseen that certain databases will be polled more frequently that other databases based on type of data contained therein. For instance, a police department database containing license plate reader data that is automatically may be polled more frequently than another a city database with personal and/or real property data.

The database server 22 is configured to normalize, adapt, and format data obtained into one or more records. The database server 22 is configured to classify the one or more records based on a predetermined data classification scheme selected by the user, e.g., via one of the user computers 20 and the configuration server 16. The database server 22 is configured to create metadata describing the data within the one or more records and store these aggregated records and the associated metadata within the memory 12 as sets of data.

Different sets of data are aggregated and correlated, e.g., via the agency server 22. At least a portion of the data is normalized and classified as either public or private, i.e., publically-accessible data accessible via an unsecured connection to via user-access server 18 or data only accessible via a secured connection via user-access server 18. The data is transmitted to the scoring server 14 along with corresponding metadata, which may be classified as law enforcement sensitive.

Any of the servers and/or computers may be configured to receive and/or transmit data therebetween either securely or non-securely. It is foreseen that data classified as law enforcement sensitive may be prevented from being received and/or transmitted between certain ones of the servers and/or computers, e.g., to/from the scoring server 14. In such a scenario, data classified as law enforcement sensitive may only reside at one or more of the computers 24. In this manner, the system 1 may comply more readily with various regulations and guidelines, e.g., regulations and guidelines associated with Criminal Justice Information Services (CJIS).

It is foreseen that any one of the servers, e.g., the scoring server 14, may be configured to connect with a variety of databases, and search for and gather data to supplement existing data contained in the memory 12. Such a search may be automatically initiated by the system 1 as the system 1 tries to update existing data contained in the memory 12 or manually initiated by one of the user computers 20. Such additional data from the variety of databases may include tax and appraisal data, public record data, vehicle registration data, consumer data, household data, credit data, census data, social media data, e.g., social media geo-tagged and geo-location data, commercial data available for purchase, and other data associated with one or more fugitives.

After the database search, collection, and processing of data as previously discussed, the data may be subjected to further correlation and analysis via the scoring server 14. The scoring server 14 is configured to identify any relationships between the data and the fugitive. The scoring server 14 is configured to assign at least one numerical value to each aspect of the data associated with the fugitive based on a number of relationships and/or a degree of strength of the relationships with respect to the data associated with the fugitive. For example, scoring may include, but is not limited to, assessment of a fugitive's age and/or an age, a make, a model and/or a condition of a vehicle associated with the fugitive. Based on preconfigured logic in the system 10, a condition of the vehicle may be inferred based on various factors, e.g., age and/or a type of citation issued to a fugitive or another associated with the vehicle. For instance, a fugitive associated with a vehicle that is twenty-six years old or older that received a moving violation may be assumed to be in good condition, based on logic, and therefore a classic. In this scenario, a high score is assigned to the fugitive, which indicates confidence in a fugitive's fiscal viability, i.e., an ability of the fugitive to pay a fine and/or fee associated with the fugitive. Likewise, a similar analysis may be used with respect to address stability, which can increase or decrease the score. On the other hand, a fugitive who received an equipment violation, such as a broken tail light or missing bumper, may be inferred based on logic to be driving an older car, e.g., an old jalopy, which would have a negative indication in terms of fiscal viability. In another example, the fact that a home listed as the home address of the fugitive is, e.g., according to tax records, owned by the fugitive or someone with the same last name as the fugitive may be inferred by the system of the present inventive concept using logic to be an indication of stability and fiscal viability, thereby increasing the score associated with the fugitive. Further, the system 10, using public, census, and/or other records may analyze the house and determine a number of rooms in the house, price paid for the house, average number of cars per home on a street associated with the house and/or in a neighborhood associated with the house to influence the score. It is foreseen that the system 10 may function automatically using one or more databases and logic, or may function as a hybrid, i.e., both automatically and manually, by presenting queries to a user to confirm existing data and/or supplement existing data with new data such as any of the aforementioned data.

Processing retrieved data using logic of the system 10 may indicate a parental status of the fugitive, a cohabitation status of the fugitive, a monthly mortgage payment, a monthly vehicle payment, which may result in a decrease or increase to the score associated with the fugitive. The score associated with the fugitive may indicate fiscal viability, stability and probability of the fugitive being home during the hours during which warrants are served during regular work hours. For instance, if the fugitive is indicated to be fiscally viable, the system 10 may deduce that the fugitive is unlikely to be home during the hours of 9 AM to 5 PM given the fugitive likely has a job.

The assignment of the score to the fugitive may include use of a series of parallel and sequentially run algorithms, which manipulate various numerical values to derive the score for the fugitive as well as any persons associated with the fugitive. The score may be influenced by a relational database in communication with the database server 22, e.g., a POSTGRESQL database. The score is securely transmitted to the database server 22, which is configured to retrieve a record of the fugitive and any others associated with the fugitive contained in the system 10. The scoring server 14 is configured to securely transmit the aggregated data, information, metadata, and score to the memory 12 for storage and/or data mining purposes, which are selectively controlled by the user.

Data sought to be retrieved by the system 10 may include, among other things, vehicle information associated with the fugitive, one or more photographs associated with the fugitive, one or more maps associated with a possible geographic location of the fugitive, other identifying information associated with the fugitive, and/or a warning that may provide details regarding a safety issue in attempting to locate the fugitive. For example, the system 10 may provide a special indicator to the user when a potentially violent fugitive is identified based on one or more prior violent offenses.

The scoring server 14 may be configured to derive from the received information contextually relevant information for identifying the strength of one or more characteristics about the fugitive. The scoring server 14 may be configured to analyze the contextually relevant information about the fugitive to generate a prioritization score indicating a maximally efficient target. The user-access server 18 may be configured to allow a user to identify one or more targets likely to be physically located. The user-access server 18 may be configured to provide a computer-based case-management of the target tracking lifecycle.

The system 10 may be configured to process information regarding one or more targets by extracting and combining information obtained from one or more of a court database, a municipal database, a state database, a federal database, a department of motor vehicles database, a commercial database, and an open source. The system 10 may be configured to convert the information into a uniform format.

The databases may be one or more of an internet record and a public record. An internet record may be an open source record published for all to see on the internet such as a blog post or other similar posting on services made available under the trademarks FACEBOOK® and TWITTER®, web page, newspaper or magazine article, etc. A public record may be an official record as filed with a government agency including, but not limited to, a municipality or county office. The system 10 may include at least one of court records of a jurisdiction, municipal records of a jurisdiction, civil court proceeding records, criminal court proceeding records, rent court records, and lease records, motor vehicle bureau records, health department records, local, state federal law enforcement records, commercial data source records, credit history records, real estate transaction records, property tax records, and a photograph posted online that is time stamped and/or location stamped.

The scoring server 14 may be configured to at least one of normalize information obtained from various sources into a single format, normalize information having various formats into a single format, normalize information having an unstructured format or is poorly structured. The normalized information may be related to the one or more targets. The normalized information may be based on one or more uniform data constructs, e.g., structured query language. The normalized information may be operable to allow at least one of searching of the information, manipulation of the information, correlation of the information, analysis of the information, and visualization of the information.

The one or more uniform data constructs may include an XML schema and/or an electronic dossier. For example, an electronic dossier may take the form of a normalized set of records each bearing a unique identifier that connects each record to a master list that intersects and connects the unique identifier to the identity of a person (e.g., their last name, first name, middle name, date of birth, driver license number and other identification). The scoring server 14 may be configured to extract a subset of the one or more uniform data constructs. The scoring server 14 may be configured to create a list of properties present across all information related to the one or more targets. The list of properties may include at least one of information related to a time period, information related to a suspect, information related to an officer, information related to a neighborhood, and information related to a jurisdiction.

The scoring server 14 may be configured to derive one or more managerial metrics related to tracking information of the one or more targets. The managerial metrics may include one or more of information related to time spent by one or more warrant officers, information related to one or more cases, information related to amount of money expended, information related to one or more targets successfully served, and information related to resources and funds expended to successfully serve one or more targets. The scoring server 14 may be configured to derive one or more performance metrics based on tracking the one or more targets. The one or more performance metrics may include costs and revenues related to an officer, team or precinct tracking the one or more targets. The costs may be calculated by man-hour expended and by amount spent. The amount spent may include vehicle mileage, toner and paper costs. The one or more targets may be ranked by costs or revenues related to the one or more targets.

The system 10 may be operable to process data to at least one of identify vehicle information, determine a level of affluence, determine a level of transience, i.e., factoring in and adjusting a report based on a possibility the one or more targets may be physically moving from one place to another within a predetermined radius and/or a predetermined timeframe, and extrapolating about past behavior of the one or more targets, i.e., factoring in and adjusting a report based on known facts regarding the one or more targets. For example, this might sometimes mean that one or more maps, e.g., of the suspected home and work addresses of a fugitive furnished by the system, and based on a comparison of the location of a violation resulting in a warrant for which the fugitive is sought to those known home and work locations the system is operable to make inferential analyses that serve to add to the overall confidence the system has in the relative ease of locating that fugitive. For example a home address in Bedford Tex. and a work Address in Arlington Tex. and a violation location of El Paso Tex. (some ten hours west of both home and work) the system might state based on a traffic offense that the relative ease to the El Paso police of locating that person is low, because locating that person would require twenty hours of driving which is economically infeasible for such an officer seeking a fugitive on such an offense. The one or more characteristics may include a possible location of the one or more targets based on known information, e.g., information obtained from a database. The one or more characteristics may include likelihood that the one or more targets are located at and/or regularly frequent a specific geographic location. The one or more characteristics may include an income source of the one or more targets. The one or more characteristics may include an assessment of ability that the one or more targets has sufficient funds to pay a fine associated with a warrant, for example, based on banking information, rent or mortgage payment information, and/or employment information.

Thus, the present inventive concept provides a system and method to gather, correlate, and analyze information to provide a user with an ability to more efficiently and safely track and arrest fugitives for whom arrest warrants have been issued, collect moneys owed by fugitives, and provide warrant management and a fugitive-tracking lifecycle. It should be noted that the present inventive concept is operable to calculate, e.g., based on objective criteria that does not consider race, creed, religion, sexual orientation, sex, or gender and display one or more records to the user.

The previous description of the presently disclosed inventive concept is provided to enable any person skilled in the art to make or use the present inventive concept. Various modifications will be readily apparent to those skilled in the art, and the generic principles defined herein may be applied alternatively without departing from the spirit or scope of the present inventive concept. Thus, the present inventive concept is not intended to be limited to the description herein but is to be accorded the widest scope consistent with the principles and novel features disclosed herein.

The steps of a method, system, or operation described in connection with the present inventive concept disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art.

Having now described the features, discoveries and principles of the present inventive aspect of this disclosure, the manner in which the present inventive aspect is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the present inventive aspect herein described, and all statements of the scope of the present inventive aspect which, as a matter of language, might be said to fall there between.

What is claimed is:

1. A computerized method to process a plurality of warrants each associated with a fugitive, the method comprising the steps of:
obtaining, via a computer system, data associated with the fugitives from at least one unsecure database;
obtaining, via the computer system, data associated with the fugitives from at least one secure database;
processing, via a processor of the computer system, (i) the data associated with the fugitives from at least one unsecure database, and (ii) the data associated with the fugitives from at least one secure database to yield a listing of the plurality of warrants; and
displaying the listing of the plurality of warrants to a user via a display of the computer system according to at least one of a plurality of orders.

2. The method of claim 1 wherein, the listing of the plurality of warrants displayed to the user is prioritized based on a likelihood of locating and serving each of the fugitives.

3. The method of claim 1 wherein, the listing of the plurality of warrants displayed to the user is prioritized based on a crime associated with each of the fugitives.

4. The method of claim 1 wherein, the listing of the plurality of warrants displayed to the user is prioritized based on a proximity of the user to each of the fugitives.

5. The method of claim 1 wherein, the listing of the plurality of warrants displayed to the user is prioritized based on a time period elapsed from issuance of each of the warrants.

6. The method of claim 1 wherein, the listing of the plurality of warrants displayed to the user is prioritized based on an amount owed by each of the fugitives.

7. The method of claim 1 wherein, the listing of the plurality of warrants displayed to the user is prioritized based on a likelihood each of the fugitives can pay an amount associated with a respective one of the fugitives.

8. The method of claim 7, wherein the amount is at least one of (i) a fine due to a government by the respective one of the fugitives, (ii) a fee due to the user by the respective one of the fugitives, and (iii) a fee due to another party by the respective one of the fugitives.

9. The method of claim 7,
wherein,
the at least one unsecure database is a publically-accessible database containing public information, and
the at least one secure database is an encrypted database containing private information that is only accessible by law-enforcement personnel.

10. A communication system with comparative analysis to identify a route to a fugitive based on data associated with a warrant for the fugitive, the system comprising:
a database server operable to retrieve data associated with the fugitive;
a memory operable to store data associated with the fugitive;
a user-access server operable to allow a user to access the system; and
a configuration server operable to allow the user to configure the system.

11. The system according to claim 10, wherein the database server, the memory, the user-access server, and the configuration server are associated with an administrative computer system.

12. The system according to claim 10, further comprising:
a user computer operable to allow the user to access the system, the user computer linked to an agency database.

13. The system of claim 10, wherein the database server is operable to retrieve data associated with the fugitive from at least one unsecure database that is a publically-accessible database containing public information, and at least one secure database that is an encrypted database containing private information that is only accessible by law-enforcement personnel.
